(19) United States
(12) Patent Application Publication
(10) Pub. No.: US 2014/0373261 A1
(43) Pub. Date: Dec. 25, 2014

(54) Decorative Toilet Bolt Cover

(71) Applicant: Carole Triantafillos, Boulder Creek, CA (US)

(72) Inventor: Carole Triantafillos, Boulder Creek, CA (US)

(21) Appl. No.: 14/204,070

(22) Filed: Mar. 11, 2014

Related U.S. Application Data
(60) Provisional application No. 61/838,732, filed on Jun. 24, 2013.

(51) Int. Cl. F16B 37/14; E03D 11/16

(52) U.S. Cl. CPC F16B 37/14; E03D 11/16
USPC 4/252.1

(57) ABSTRACT

A decorative toilet bolt cover is provided that allows users to customize an area of their bathroom that is ordinarily merely utilitarian and dull. Toilet bolts are used to secure toilets to the bathroom floor and are omnipresent, yet there are no options available to decorate these toilet bolts. Covers are necessary for these toilet bolts because exposed bolts are ugly and can be dangerous since they are hard, potentially rusty protuberances. Traditional toilet bolt covers do not offer the range of design options that many users would like, therefore there is a need for decorative toilet bolt covers that are easy to secure to exposed toilet bolts.

### CROSS REFERENCE TO RELATED APPLICATION

This application claims the benefit of U.S. Provisional Application No. 61/838,732 filed on Jun. 24, 2013. The above identified patent application is herein incorporated by reference in its entirety to provide continuity of disclosure.

### BACKGROUND OF THE INVENTION

### Field of the Invention

The present invention relates to ornamental bathroom decorations.

More specifically, the present inventions relates to novelty coverings for exposed toilet bolts.

Toilet bolts are critical to the function of the toilet because they keep the fixture in place during use, but the toilet bolts require covers to protect individuals from the exposed threaded portions and make the structure more aesthetically pleasing. However, the caps used to cover the toilet bolts often fall off over time or are themselves ugly. Therefore, there is a need for decorative toilet bolt covers to replace the ugly or dull toilet bolt covers that came with the fixture or to cover the exposed bolt sections of toilets whose bolt covers have been lost. Exposed bolts on toilets can be a hazard, in addition to an eyesore, since such bolts have hard, jagged edges and are potentially rusty because the metal is exposed to a substantial amount of moisture by virtue of its position in the bathroom. Toilet bolt cover replacements also provide individuals with the opportunity to put their own unique stamp on the bathroom environment, turning a generally ugly thing into a positive.

Current toilet bolt covers are utilitarian in design and fail to seize the opportunity to offer individuals an additional way for them to decorate their home. The present decorative toilet bolt cover solves this issue by providing anyone who needs to cover their toilet bolts with a fun and unique solution. The present invention is easy to install over an exposed toilet bolt and comes in a variety of sizes, shapes, and designs so that anyone can find a toilet bolt cover that fits their style.

### DESCRIPTION OF THE PRIOR ART

Devices have been disclosed in the prior art that relate to toilet bolt coverings. These include devices that have been patented and published in patent application publications. These devices generally relate to an ornamental portion having a threaded recess adapted to engage with the exposed threading of a toilet bolt. The following is a list of devices deemed most relevant to the present disclosure, which are herein described for the purposes of highlighting and differentiating the unique aspects of the present invention, and further highlighting the drawbacks existing in the prior art.

Toilet bolt coverings are known in the prior art and come in a variety of designs, such as U.S. Design Pat. Nos. D417,491 and D527,810. Such designs are primarily utilitarian and not decorative in an aesthetically pleasing way. Even covers for generic bolts, such as U.S. Design Pat. Nos. D654,421 and D662,409, are generally not ornamental or decorative in any way. This is a drawback because it represents a lost opportunity to make more efficient use of space and to give users additional choice in the way in which they can decorate their bathrooms and fixtures.

The present invention provides a novel means for adding decoration to one's bathroom by taking advantage of a traditionally underutilized space. The present toilet bolt cover comes in a wide variety of designs and colors to suit all manner of tastes and styles. The present invention performs the standard toilet bolt cover task of protecting individuals from the protrusion, but does so while also providing individuals with much more opportunity to pick something that they find aesthetically appealing. It substantially diverges in design elements from the prior art and consequently it is clear that there is a need in the art for an improvement to existing toilet bolt cover devices. In this regard the instant invention substantially fulfills these needs.

### SUMMARY OF THE INVENTION

In view of the foregoing disadvantages inherent in the known types of bolt covers now present in the prior art, the present invention provides a new toilet bolt cover wherein the same can be utilized for providing convenience for the user when decorating one's bathroom.

It is therefore an object of the present invention to provide a new and improved toilet bolt cover device that has all of the advantages of the prior art and none of the disadvantages.

It is another object of the present invention to provide a toilet bolt cover that is aesthetically pleasing.

Another object of the present invention is to provide a toilet bolt cover that is available in a wide variety of shapes, colors, and designs.

Yet another object of the present invention is to provide a toilet bolt cover that protects individuals from injury from an exposed toilet bolt.

Yet another object of the present invention is to provide a toilet bolt cover that is easy to secure over the exposed portion of a toilet bolt.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the present invention aligned with the exposed portion of a bolt, prior to being placed thereon.

FIG. 2 shows a perspective view of an embodiment of the present invention secured over a toilet bolt.

FIG. 3 shows a cross-sectional view of an alternate embodiment of the present invention secured over a toilet bolt.

FIG. 4 shows a cross-sectional view of an alternative embodiment of the present invention having an additional securement means.

FIG. 5 shows a cross-sectional view of an alternate embodiment of the present invention.

### DETAILED DESCRIPTION OF THE INVENTION

Reference is made herein to the attached drawings. Like reference numerals are used throughout the drawings to depict like or similar elements of the toilet bolt cover. For the purposes of presenting a brief and clear description of the present invention, the preferred embodiment will be discussed as used for decorating one's bathroom. The figures are intended for representative purposes only and should not be considered to be limiting in any respect.

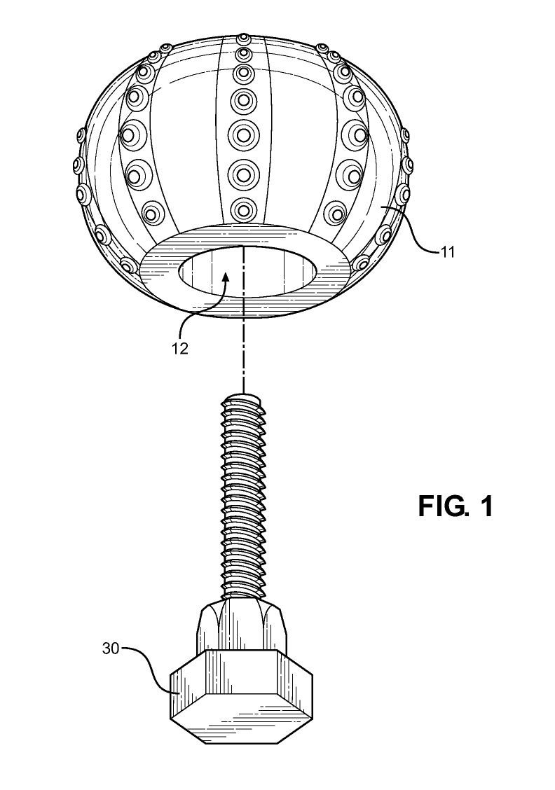

Referring now to FIG. 1, there is shown a perspective view of the present invention aligned with the exposed portion of a bolt, prior to be secured thereon. The present invention comprises a cover body 11 and an elongated recess 12. The cover body 11 as depicted is dome-shaped with a plurality of aligned vertical stripes and a plurality of decorative pieces thereon, but the cover body 11 can be provided in a wide variety of aesthetically-pleasing designs. No claim is made as to the specific shape, design, color, or configuration of the present decorative toilet bolt cover. The cover body 11 may be composed of ceramic, plastic, or any other type of suitable material.

The present invention is designed to be available in a wide range of ornamental designs in order to provide users with a large variety of potential decorative options for their bathrooms. The present invention also functions as a traditional bolt cover by protecting users from the potential hazard of an exposed toilet bolt. The exposed threaded portion of a toilet bolt can be dangerous to users because it is a hard protuberance with jagged, threaded edges that could potentially hurt users in a variety of ways. Therefore, there is a need to cover the exposed threaded portion with a more rounded, less dangerous covering that will help prevent injuries. This bolt covering need not be strictly utilitarian and ugly, as is the case with current bolt covers, despite its utilitarian purpose. Individuals are always looking for new and creative ways of decorating their bathroom and the present invention provides users with a previously unrecognized opportunity to do so.

The elongated recess 12 of the present invention is a substantially hollow recess within the cover body 11 that is adapted to securely fit around the exposed portion of a toilet bolt. The present invention is created by an injection molding procedure and the elongated recess 12 is integrally created within the cover body 11 during fabrication. The bottom portion of the elongated recess 12 is designed to firmly fit around the nut of the toilet bolt that is securing the toilet bolt to the base of the toilet. The fit of the elongated recess 12 around the nut of the toilet bolt is preferably tight enough such that the present invention cannot be removed or jostled therefrom without intentional effort on the part of the user. The firm fitting of the elongated recess 12 over the nut of the toilet bolt helps to ensure that the device will properly function as a safety device because the present invention will not fall off, be kicked off, or otherwise be accidently removed from covering the toilet bolt.

The elongated recess 12 has a wide range of potential designs and configurations, although it will always generally comprise a hollow recess in the cover body 11 that is designed to firmly fit around the exposed portion of a toilet bolt. In one embodiment the elongated recess 12 comprises a roughly cylindrical hollow recess within the cover body 11 that has a wider base portion that is adapted to be secured around the nut on the toilet bolt and a narrower upper portion to conform to the remaining protruding threaded portion. No specific claim is made as to the shape of the elongated recess 12, however, except that the base portion of the elongated recess 12 must be designed so as to tightly fit around the nut secured onto a toilet bolt so as to tightly secure the present invention thereto.

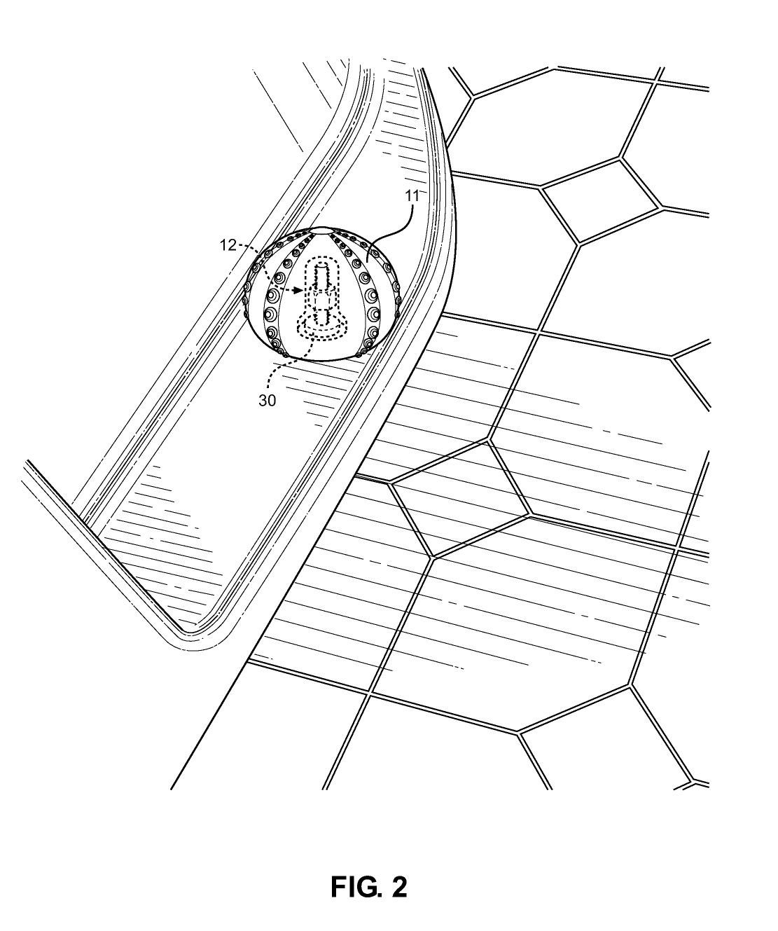

Referring now to FIG. 2, there is shown a perspective view of an embodiment of the present invention secured over a toilet bolt. In no way is the present disclosure intended to be limiting as to the size, shape, design, color, or configuration of the present invention, because a wide range of aesthetically-pleasing designs are contemplated. The depiction contained in FIGS. 1 and 2 is merely intended to provide an exemplary design to assist in demonstrating the potential types of designs of the present invention.

The preferred embodiments of the present invention will have a generally rounded or curved surface in order to enhance their safety characteristics. Toilet bolts covers with rounded surfaces more easily deflect physical impact that would otherwise catch or snag on the protuberance that is a toilet bolt. There is a wide range of potential designs, however, and thus no specific claims is made as to the exterior shape of the cover body 11.

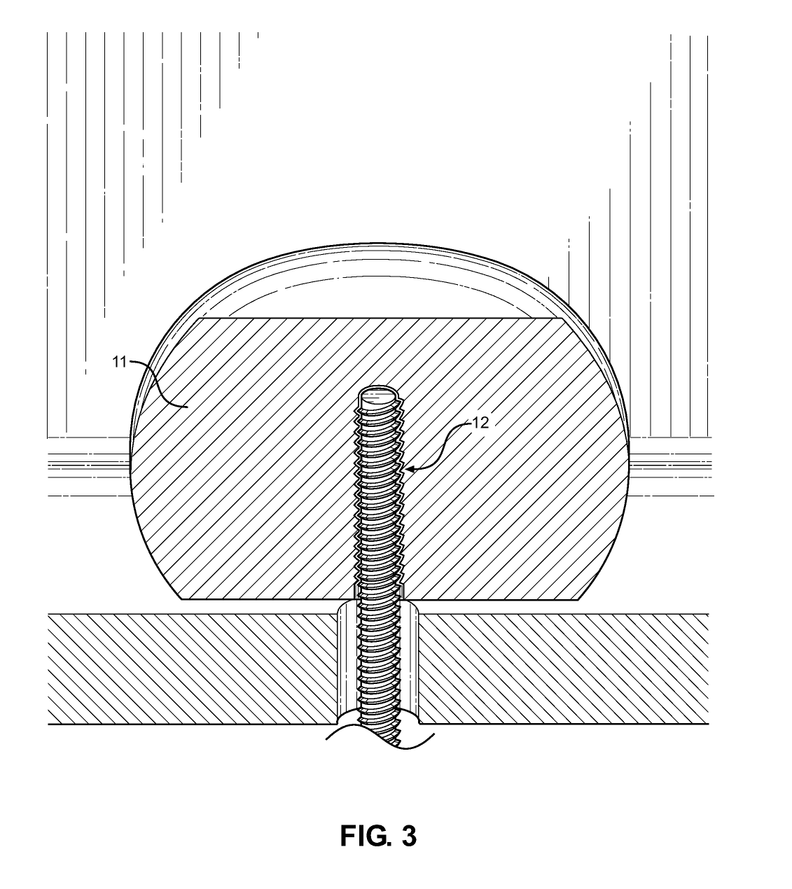

Referring now to FIG. 3, there is shown a cross-sectional view of an alternative embodiment of the present invention. In the alternative embodiment, the elongated recess 12 of the present invention is not an open recess, as discussed above, but rather a threaded opening through the cover body 11. This allows the device to be directly secured onto the exposed threaded portion of the toilet bolt, ensuring that the bolt cover will be securely fastened thereto. In this embodiment, rather than tightly fitting over the toilet bolt nut, the present invention replaces the nut. In this embodiment, the present invention both secures the toilet firmly to the floor of the bathroom via replacement of the nut and also provides a cover for the normally exposed threaded portion to reduce the risk of injury.

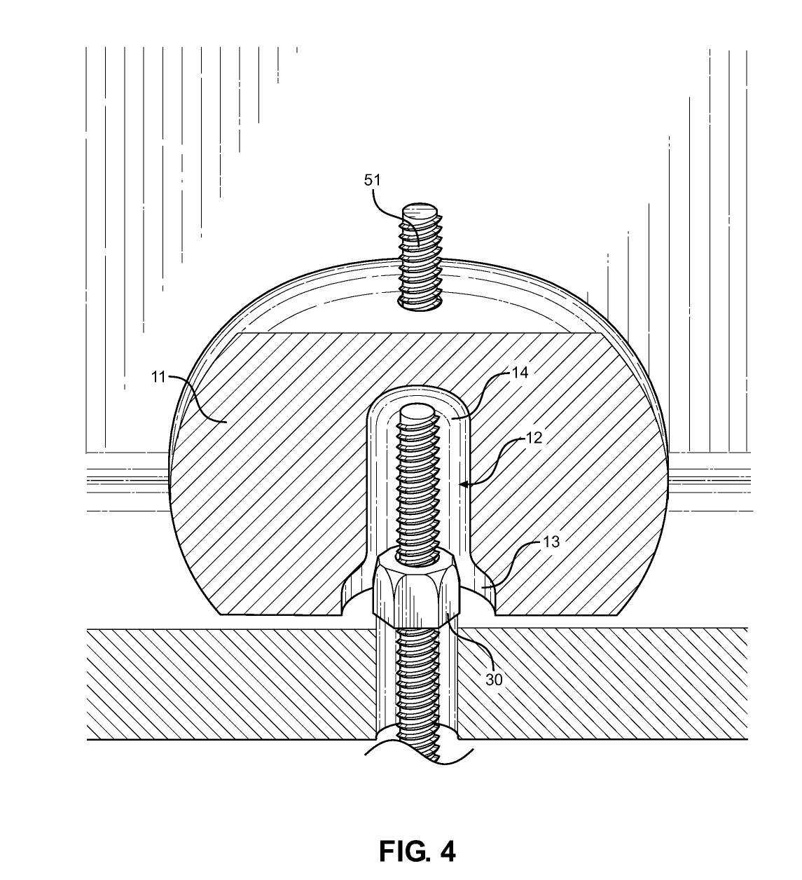

Referring now to FIG. 4, there is shown a cross-sectional view of an alternate embodiment of the preset invention having an additional securement means. The depicted alternate embodiment has an additional securement means 51 attached to the exterior of the cover body 11. This securement means 51 is provided to permit a second ornamental decoration to be attached to the cover body 11, thereby even more greatly increasing the number of potential decorative options available to users. In the depicted embodiment the securement means 51 comprises a threaded portion extending from the top of an embodiment of the cover body 11, however no specific claim is made as to the structure of the securement means 51, except that it is adapted to allow additional ornamental objects to be secured thereto. For example, the securement means 51 could also comprise a hook-and-loop fastener.

The elongated recess 12 in this embodiment comprises a base portion 13 adapted to fit over the nut secured on a toilet bolt 30 and an upper portion 14 adapted to fit over the protruding portion of a toilet bolt 30. In this embodiment, like in FIGS. 2 and 3, the elongated recess 12 of the present invention is substantially cylindrical and is adapted to fit over the entire length of the exposed portion of the toilet bolt 30, providing a protective cover. The base portion 13 has a first diameter such that it can accept the nut portion of the toilet bolt 30 and the upper portion 14 has a diameter such that it can accept the exposed threaded portion of the toilet bolt 30. The elongated recess 12 preferably securely and snugly fits around the nut portion of the toilet bolt 30, but does not necessarily need to, as long as it can be placed thereover.

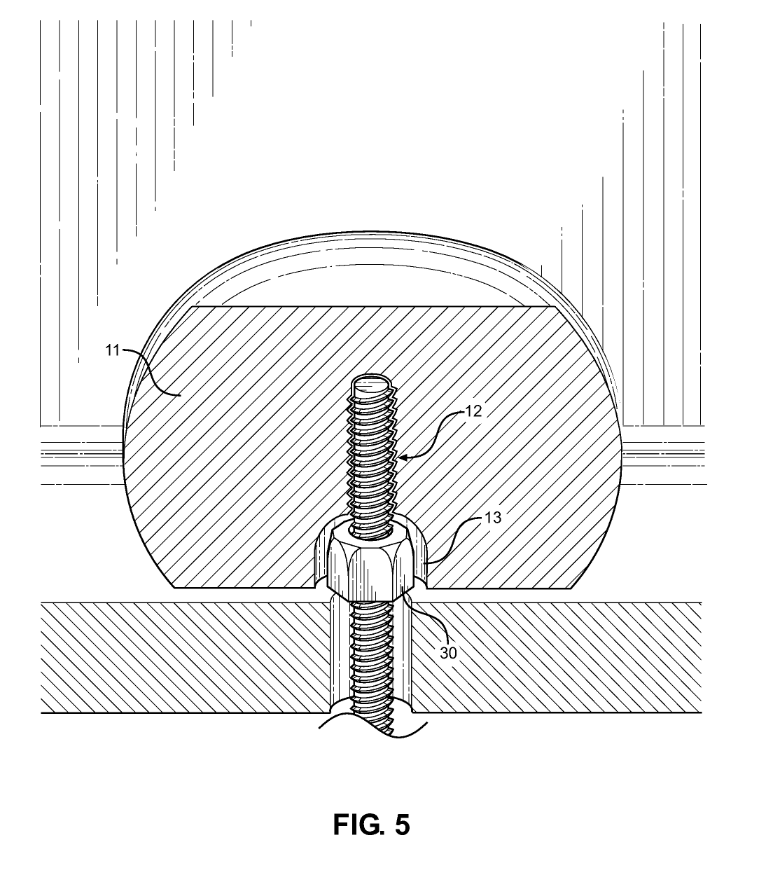

Referring now to FIG. 5, there is shown a cross-sectional view of an alternate embodiment of the present invention. In this embodiment, the elongated recess 12 comprises a base portion 13 that is adapted to fit over the nut of a toilet bolt 30 and a threaded top portion. The base portion 13 has a diameter equal to or larger than the diameter of a toilet bolt 30 nut. The threaded portion has a complimentary threading such that it can engage with the exposed threaded portion of a toilet bolt 30. The elongated recess 12, as depicted herein, can comprise a substantially cylindrical recess having a first diameter and a second diameter, a fully threaded opening designed to be used with a toilet bolt 30 lacking a nut, and a hybrid design having an open base portion 13 and a threaded top portion.

In use an individual chooses the design of the present toilet bolt cover that he or she wishes to use and then secures said toilet bolt cover over the exposed portion of the toilet bolt. For some embodiments the present invention is threaded onto the toilet bolt cover, whereas in others the present invention is merely placed thereon. Overall, the present invention provides a new and novel means to add decoration to a normally dull and boring area of one's bathroom.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A decorative toilet bolt cover, comprising:
a cover body having a flat lower surface, an aperture through said lower surface, and an elongated recess extending into said cover body from said aperture;
said elongated recess adapted to accept an exposed toilet bolt therein;
said cover body and said elongated recess being adapted to shroud the entirety of said toilet bolt length;
said cover body having an outer ornamental shape.

2) The decorative toilet bolt cover of claim 1, further comprising an external securement means extending from the exterior of said cover body, said external securement means adapted to secure an external ornamental article to said cover body.

3) The decorative toilet bolt cover of claim 2, wherein said external securement means comprises a threaded shank member.

4) The decorative toilet bolt cover of claim 1, wherein said elongated recess comprises a diameter adapted to tightly fit a nut of a toilet bolt.

5) The decorative toilet bolt cover of claim 1, wherein said elongated recess comprises threaded recess walls and a diameter adapted to threadably secure to an exposed portion of a toilet bolt.

6) The decorative toilet bolt cover of claim 1, wherein:
said elongated recess comprises threaded recess walls and a diameter adapted to threadably secure to an exposed portion of a toilet bolt;
said aperture of said elongated recess having a diameter adapted to accept a nut secured along said toilet bolt.
